(19) United States
(12) Patent Application Publication
(10) Pub. No.: US 2005/0153264 A1
(43) Pub. Date: Jul. 14, 2005

(54) READING SYSTEM

(76) Inventor: Max F. Morris, Winter Park, FL (US)

Correspondence Address: William M. Hobby, III, 157 E. New England Avenue, #375, Winter Park, FL, 32789, US

(21) Appl. No.: 10/755,159

(22) Filed: Jan. 12, 2004

(51) Int. Cl. G09B 17/04

(52) U.S. Cl. 434/179

(57) ABSTRACT

A speed reading system includes a plurality of printed sheets, each sheet having a pair of vertically extending scan bars and a plurality of printed lines of indicia extending perpendicular to the scan bars. Selected printed lines of indicia have a plurality of grouped scan words therein with each scan word being in a different font and larger type than the non-scanned words and each group of scan words being positioned with the first scanned word in the group in one line being adjacent to the vertically extending scan bars. A plurality of scan line indicators are located adjacent and between the scan bars with one scan line indicator being adjacent each scan line having at least one scan word therein with each scan line indicator being indicative of a line having scan words therein.

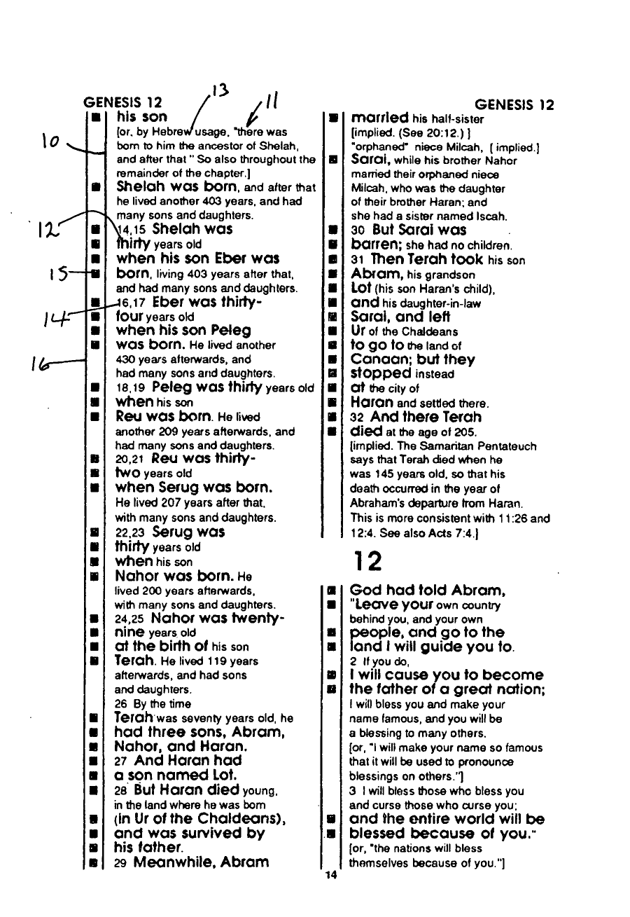

### BACKGROUND OF THE INVENTION

The present invention relates to a reading system for speed reading texts, and especially to a system using scan bars, scan words and scan indicators. This invention is an improvement over my prior U.S. Pat. No. 4,643,450 of Feb. 17, 1987. There are a wide variety of techniques used for teaching speed reading and to enable readers to speed up the reading to cover more material in less time while enhancing the retention of the material read. The closest prior art to the present invention are those techniques particularly directed to guiding the movement of the reader's eye from one line or line group of printed material to the next succeeding line or line group. It has also been suggested that prior technique for studying includes underlining text material, or reading in phrases rather than by individual words so that articles and certain types of words can be ignored. Thus, the format of the reading, such as a page or column, needs to have relatively short lines and relatively wide spaces from each other to avoid the difficulty of skipping material.

The present invention is directed towards a printing technique in which books, pamphlets, papers or flyers can be produced for the rapid reading in which a variety of techniques are integrated into single reading columns located on each page including the rapid reading of computer internet pages. These techniques enhance the ability of the individual to rapidly scan and comprehend the material by keeping the reader's eye aligned with the scan bar while selecting words to be scanned which are printed in a larger bold type of a different font from the unscanned text and having scanned line indicator marks for directing the eye towards the scanned material. Experimentations have shown that anyone with minimal practice can substantially increase their speed of reading and material covered using the present system.

Prior art U.S. patents which utilize techniques for scanning, reading or using a phonic alphabet may be seen in the Shapiro U.S. Pat. No. 3,611,593 for a line group sequential reading aid, in which selected lines have a visible symbol adjacent thereto. This system aids the eye of the reader in following the sequences of lines to be read by providing marginal indicia at the start of each line or line group to guide the reader's eye to the start of the next succeeding line group to be read and to tie in the starting indicia with like indicia at the end of the proceeding line group. U.S. Pat. No. 3,426,451 to Hoffman shows a phonic alphabet in which a font of alphabetical letters is used for teaching, spelling and reading. The U.S. patent to Sheffield, U.S. Pat. No. 1,456,834, shows an art of printing, which uses a variety of type fonts and styles, all intermixed within each paragraph so that each group of elements are separated throughout the printed material. In U.S. Pat. No. 875,756 to Warren, a stenographer's notebook is shown with vertical and horizontal lines.

My prior U.S. Pat. No. 4,643,450 is for a reading system and process for printing and reading text which uses a scan bar to scan words and scan indicators. A plurality of printed sheets are provided, each having at least one vertical extending scan bar and a plurality of short printed lines of indicia, which are printed perpendicular to the scan bar with certain lines having scan words therein in a bold or a different colored type font. The plurality of scan line indicators are placed adjacent to the scan bar and adjacent each scan line having scan words.

The present invention is an improvement over my prior patent which enhances and speeds up the reading of text by using boldface words in one font and lightface words in another font to more rapidly distinguish to the eye and having the boldface words larger than the lightface words so that the eye of the reader moves more rapidly through the scanned words and also having all of the scan words start at the scan bar for rapid location of the scan words and in order to eliminate horizontal eye movement when scanning the text. In addition, the boldface words always form a complete sentence or thought and are placed on column lines of no more than 1 and ½ inches wide. These enhancements make for more rapid reading of the text in the present reading system.

### SUMMARY OF THE INVENTION

A speed reading system includes a plurality of printed sheets, each sheet having a vertically extending scan bar and a plurality of printed lines of indicia extending perpendicular to the scan bar. Selected printed lines of indicia have a plurality of grouped scan words therein with the scanned words in a different font and larger bold type than the non-scanned words and each group of scanned words being positioned with the first scanned word in each group in one line being adjacent to the vertically extending scan bar. A plurality of scan line indicators are located adjacent to the scan bar with one scan line indicator being adjacent each scan line having at least one scan word therein with each scan line indicator being indicative of a line having scan words therein. A second scan bar is placed parallel to the first scan bar on the other side of the scan line indicators. Each scan line is less than four centimeters long. Each scan word may be two points larger than each non-scanned word so that a person reading the plurality of printed sheets can rapidly scan each column of printed text.

### BRIEF DESCRIPTION OF THE DRAWINGS

Other objects, features, and advantages of the present invention will be apparent from the written description and the drawings in which the drawing is a sample of printed text in accordance with the present invention.

### DESCRIPTION OF THE PREFERRED EMBODIMENT

Referring to the drawing, a sample of reading text using the present reading system is illustrated in which each column on each page has at least one scan bar 10 running vertical on the page of material and having short lines or phrases of printed scan lines 11 extending perpendicular to the scan bar 10 running down the page of the right side of the scan bar 10. The scan lines 11 include scan words 12 which are printed in a bold type of a different font from the non-scanned words 13 within the text. The scan words 12 may be, for instance, printed in a bold text which is two points larger than the standard text 13, such as a 10 point bold faced font and an 8 point light font. A different font is used to make the scan words readily discernable by the eye in a rapid scanning of the text. Each line 11 of the text, which has a scan word 12 therein, has one of the scan words starting adjacent the scan bar 10 except for the text identification numbers 14. A plurality of scan indicators 15 may be square black dots or the like and placed adjacent the scan bar 10 and placed adjacent to each line 11 having a scan word 12 in the line so as to readily draw attention to each scan line which has scan words therein. Each column of text has a second scan bar 16 placed parallel to the scan bar 10 on the opposite side of the scan indicators 15. In addition, each scanning line of text 11 is less than four centimeters long or no more than about 1½ inches or about 4 cm, thus allowing two or more columns to be placed on the same sheet.

To read the materials shown in the Figure, a reader learns to read each entire line of scanned words rather than the individual words. The lines are made of a length that can be easily read a phrase at a time as one scans from the top of the column to the bottom of the column without shifting the eyes from one side to the other. The scan indicator 15 focuses the eye on each scan line having scan words in which the scan words are of a different font and of a considerably larger font than the non-scan words and each is made to start from adjacent the scan bar 10 to make for the rapid alignment of the eye during the rapid scanning of each column. The short columns allow the eye to go from the top to the bottom without shifting from left to right during the scanning. Thus when reading, the eye follows the scan bars 10 and 16 from top to bottom reading each phrase of scanned words as one moves from one scan indicator 15 having scan words 12 therein to the next. The scan words 12 are automatically emphasized so that study aids, such as underlining, are not necessary and the fast reading allows a quick scan at a much greater rate of reading and comprehension. The system advantageously takes only minimal learning to substantially increase the speed of reading the materials so that a person is able to cover large amounts of material in a much shorter period of time. The reading system of the present invention is enhanced by the use of columns of no more than 1 inch to an 1½ (about 4 cm) to thus eliminate the left-to-right eye movement and by having the boldface scanned words of one font while the light faced non-scan words are of a different font and are not bold faced. Each bold faced word may be two points larger than each of the light faced words. For example, the bold faced words can be ten points while the light faced words can be eight points. All bold faced words come back to the scan bar adjacent a scan indicator to maintain the focus of the movement of the eye during scanning to scan straight down one column without losing one's place. Every word of text in a book, such as in the bible, as illustrated, is printed with nothing left out so that a person desiring to fill in the scanned text, has the option to do so at any time.

It should be clear that the present invention is directed towards a printing system in which books, pamphlets, papers, or flyers can be produced for rapid reading in a variety of techniques integrated into a single reading column located on each page. This technique enhances the ability to rapidly scan and comprehend the material by keeping the readers eye aligned with the scan bar 10 and focused on the lines by the scan indicator 15 having the scanned words 12 of a larger bold type font and of a different type font than the non-scan words which provide a natural flow of the eye over the scanned material. However, it should be clear that the present invention is not to be considered as limited to the forms shown which is to be considered illustrative rather than restrictive.

1. A speed reading system comprising:
a plurality of printed sheets, each sheet having a vertically extending scan bar;
a plurality of printed lines of indicia extending perpendicular to said scan bar and selected printed lines of indicia having a plurality of grouped scan words therein, each scan word being in a different type font and in a bolder and larger type than each non-scan word and each group of said grouped scan words being positioned with the first scan word in each group of scanned words in one line being adjacent said vertically extending scan bar;
a plurality of scan line indicators located adjacent to the scan bar, and one scan line indicator being adjacent each scan line having at least one scan word therein, each said scan line indicator being indicative of a line having at least one scan word therein, and
a second scan bar being placed parallel to the first scan bar on the other side of the scan line indicators.

2. The speed reading system in accordance with claim 1 in which each scan line indicator is a solid color square.

3. The speed reading system in accordance with claim 1 in which each scan line is less that 4 cm long.

4. The speed reading system in accordance with claim 3 in which each scan word is 2 points larger than non-scan words.
